(19) United States
(12) Patent Application Publication
(10) Pub. No.: US 2025/0111274 A1
(43) Pub. Date: Apr. 3, 2025

(54) SYSTEM AND METHOD USING MACHINE LEARNING FOR DETERMINING PROBABILITY OF INCIDENT OCCURRENCE

(71) Applicant: The Prudential Insurance Company of America, Newark, NJ (US)

(72) Inventors: Thomas C. Kennedy, Scranton, PA (US); Jaxon Gummi, Castle Rock, CO (US); Daniel Sabol, Royersford, PA (US); Brent P. Matthews, Stevens Point, WI (US); Michael Baker, Milford, PA (US); Edwaed Martinez, Rockway, NJ (US)

(73) Assignee: The Prudential Insurance Company of America, Newark, NJ (US)

(21) Appl. No.: 18/781,386

(22) Filed: Jul. 23, 2024

Related U.S. Application Data
(60) Provisional application No. 63/541,590, filed on Sep. 29, 2023.

(51) Int. Cl. G06N 20/00

(52) U.S. Cl. CPC G06N 20/00

(57) ABSTRACT

A computer-implemented method and system for determining a probability of incident occurrence resulting from one or more changes to one or more computer networked applications. A machine learning (ML) model is trained to identify probability of likelihood of one or more incidents from occurring to one or more computer applications attributable to one or more changes to the one or more computer applications. Information is received corresponding to at least one application change attribute, which is then analyzed by the trained ML model to identify one or more incident occurrence indicators applicable to the at least one application change attribute. A probability of one or more incidents occurring is then determined corresponding to the at least one application change attribute.

### CROSS REFERENCE TO RELATED APPLICATIONS

This application claims priority to U.S. Patent Application Ser. No. 63/541,590 filed Sep. 29, 2023, which is incorporated herein by reference in its entirety.

### FIELD OF THE INVENTION

The illustrated embodiments generally relate to systems, methods, and apparatuses for determining a probability of an incident occurring from one or more attributes of scheduled application changes relating to one or more computer applications, and more particularly to training, and utilizing, a M L model for determining a probability of an incident occurring from one or more application change attributes relating to one or more computer applications.

### BACKGROUND OF THE INVENTION

Computer incident response has become an important component of information technology (IT). For instance, thousands of changes occur in enterprises every day to various business computer applications. Sometimes a change to a network/application results in unforeseen and undesirable incident occurrences to one or more networked computer applications. Such undesirable incident occurrences often leads to outages resulting in broad disruption in business services, consequently causing a significant financial impact and reputational damage to an enterprise.

Existing applications for affecting changes to software applications executing on an enterprise platform, such as ServiceNow™, may be either enterprise based, or cloud-based software-as-a-service (SaaS) platforms, that typically utilize AI to automate business processes and management workflows for enterprises. They are essentially tools that allows users to build, test, and implement applications for challenges like case management, operations management, and service management. However, a significant shortcoming of such applications is they are unable to predict the often-undesirable incident occurrences as mentioned above.

Thus, there exists a need to provide an improved system AI tool that integrates with platforms, such as ServiceNow™. Additionally, a need exists for providing incident detection and response capabilities which are highly desirable for rapidly detecting incidents, minimizing disruptions, and providing early indication of the likelihood of an incident.

### SUMMARY OF THE INVENTION

The purpose and advantages of the illustrated embodiments will be set forth in and apparent from the description that follows. Additional advantages of the illustrated embodiments will be realized and attained by the devices, systems and methods particularly pointed out in the written description and claims hereof, as well as from the appended drawings.

Generally, described herein, is a computer system, method and/or apparatus configured to utilize Machine Learning (ML) techniques to determine the probability of an incident occurring from one or more application attributes of scheduled application changes (“change attributes”) relating to an application. This is particularly advantageous in that it enables application administrators implementing the one or more application change attributes to understand the potential impact to the application resulting from the one or more application change attributes so as to prepare proactively for any potential impacting incidents. In accordance with the illustrated embodiments, by leveraging ML techniques, a trained ML model enhances operational efficiency and minimizes risks associated with abnormal events associated with the one or more application change attributes. Thus, the trained ML model preferably provides indication of the likelihood of an incident occurring via probabilistic machine learning modeling. This determination/prediction preferably provides early identification and heightened awareness of any potential impacts caused by certain contemplated application change attributes. For instance, this is particularly advantageous in that it enables application/network administrators responsible for the application change attributes to make adjustments to the application change attributes prior to actual implementation so as to remediate incidents that would otherwise have resulted to an application. Hence, a network monitoring device implements the aforesaid trained ML model for determining the probability of an incident occurring from one or more application change attributes relating to an application. This preferably provides heightened awareness, leading to monitoring the implementation of application change attributes to provide notification of potential undesirable impacts to an application which then may be proactively remediated.

In accordance with a purpose of the illustrated embodiments, in one aspect described herein is a computer-implemented method and system for determining a probability of incident occurrence resulting from one or more changes to one or more computer applications. A Machine Learning (ML) model is trained, preferably via one or more ML training techniques, to identify probability of likelihood of one or more incidents from occurring to one or more computer applications attributable to one or more changes to the one or more computer applications. Training the ML model preferably includes utilization of historical data from a prescribed time period consisting of application changes and resulting incident occurrences caused by the application changes, wherein processing the historical data may further include creating groupings from the historical data, extracting optimal timeframe data from the historical data, and encoding application change attributes. Additionally, in certain embodiments, one or more of Receiver Operator Characteristic (ROC) and Area Under the Curve (AUC) calculations are utilized to identify visually optimal probability decision points for training the ML model.

Once a ML model is trained, the accuracy of the trained ML model is determined by preferably determining a probability of incident occurrence by using a F1 score (e.g., to combine the precision and recall metrics into one metric) for improving the performance of a binary classification model. Preferably, an optimized trained ML model is selected, which preferably includes determining an optimal ML model with optimized hyperparameters preferably utilizing grid search capabilities or randomized search. Preferably, the optimal hyperparameters are set using a grid search method or randomized search. In certain embodiments, a confusion matrix is utilized to summarize performance of the ML model on a set of test data used for training the ML model, wherein the confusion matrix is preferably computed using a confusion matrix function applied to true and predicted labels, which includes computing true positive (TP), false positive (FP), false negative (FN), and true negative (TN) values for the output layer.

The ML model preferably includes a plurality of input parameters each corresponding to a different application change attribute, and an output having output labels and weights. Information is received corresponding to the change attributes, which is then analyzed by the trained ML model to identify one or more incident occurrence indicators applicable to the at least one application change attribute. Preferably each incident occurrence indicator includes a label and a weight output from the output of the trained ML model. A probability of one or more incidents occurring is then determined corresponding to the change attributes.

In certain embodiments, training a ML model to determine a probability of incident occurrence resulting from one or more changes to one or more computer applications includes processing at least historical incident occurrence records that include historical changes and incident records relating to one or more applications. Processing the historical incident changes and incident records in certain embodiments includes converting unstructured data to structured data for processing by the ML model, and may further include performing Natural Language Processing (NLP) techniques to transform at least a portion of the historical incident changes and incident records for processing by the trained ML model.

In certain embodiments, the trained ML model is implemented periodically to determine a probability of incident occurrence resulting from one or more scheduled changes to one or more computer applications. In other embodiments, the ML model is integrated with an IT management workflow application, such as the ServiceNow™ application for managing incident, problem and change IT operational events. For instance, a Representational State Transfer (REST) application program interface (API) may be provided for integrating the ML model with the IT management workflow application such that the output of ML model is provided via the REST API for providing notice to a user of the probability of one or more incidents occurring corresponding to the at least one application change attribute.

In certain illustrated embodiments, further included is generation of a display (e.g., dashboard) on a user's computer device visual indicating performance metrics associated with the model scoring regarding the probability of incident occurrence resulting from one or more changes to one or more computer applications. Additionally, certain embodiments include generating, and exporting to a database, Python objects (e.g., a Pickle file) for serializing and deserializing the output layer indicative of the probability of incident occurrence resulting from one or more changes to one or more computer applications, for subsequent use by the ML model.

In another aspect, the trained ML model is configured to provide real-time indication of a probability of incident occurrence resulting from one or more changes (e.g., contemplated application changes) to one or more computer applications.

### BRIEF DESCRIPTION OF THE DRAWINGS

The accompanying appendices and/or drawings illustrate various, non-limiting, examples, inventive aspects in accordance with the present disclosure:

FIG. 1 illustrates an example communication network utilized with one or more of the illustrated embodiments;

FIG. 2 illustrates an example network device/node utilized with one or more of the illustrated embodiments;

FIG. 3 illustrates a diagram depicting an Artificial Intelligence (AI) device utilized with one or more of the illustrated embodiments;

FIG. 4 illustrates a diagram depicting an AI server utilized with one or more of the illustrated embodiments;

FIG. 5 is a flow diagram illustrating an exemplary computer implemented method for determining a probability of incident occurrence resulting from an application change attributes in accordance with the illustrated embodiments of FIGS. 1-4;

FIGS. 6A and 6B illustrate exemplary screen shots depicting a process for a user to input on or more scheduled change attributes; and

FIGS. 7A and 7B illustrate dashboard types of displays graphically illustrating incident occurrence in accordance with the illustrated embodiments of FIG. 1-6.

### DETAILED DESCRIPTION OF CERTAIN EMBODIMENTS

The illustrated embodiments are now described more fully with reference to the accompanying drawings wherein like reference numerals identify similar structural/functional features. The illustrated embodiments are not limited in any way to what is illustrated as the illustrated embodiments described below are merely exemplary, which can be embodied in various forms, as appreciated by one skilled in the art. Therefore, it is to be understood that any structural and functional details disclosed herein are not to be interpreted as limiting, but merely as a basis for the claims and as a representation for teaching one skilled in the art to variously employ the discussed embodiments. Furthermore, the terms and phrases used herein are not intended to be limiting but rather to provide an understandable description of the illustrated embodiments.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the illustrated embodiments, exemplary methods and materials are now described.

It must be noted that as used herein and in the appended claims, the singular forms “a” “an,” and “the” include plural referents unless the context clearly dictates otherwise. Thus, for example, reference to “a stimulus” includes a plurality of such stimuli and reference to “the signal” includes reference to one or more signals and equivalents thereof known to those skilled in the art, and so forth.

It is to be appreciated the illustrated embodiments discussed below are preferably a software algorithm, program or code residing on computer useable medium having control logic for enabling execution on a machine having a computer processor. In accordance with the illustrated embodiments, machine learning techniques are preferably utilized for determining the probability of an incident occurring to one or more computer applications from one or more application change attributes relating to one or more computer applications.

As used herein, the term “software” is meant to be synonymous with any code or program that can be in a processor of a host computer, regardless of whether the implementation is in hardware, firmware or as a software computer product available on a disc, a memory storage device, or for download from a remote machine. The embodiments described herein include such software to implement the equations, relationships and algorithms described above. One skilled in the art will appreciate further features and advantages of the illustrated embodiments based on the above-described embodiments. Accordingly, the illustrated embodiments are not to be limited by what has been particularly shown and described, except as indicated by the appended claims.

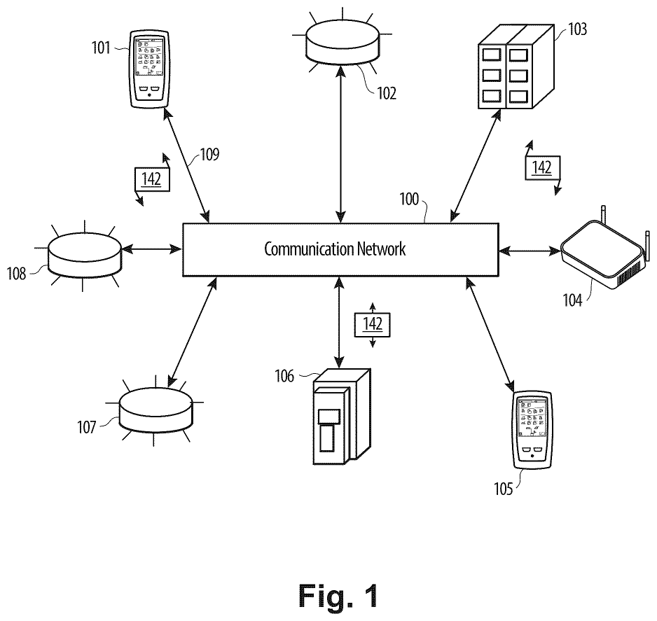

Turning now descriptively to the drawings, in which similar reference characters denote similar elements throughout the several views, FIG. 1 depicts an exemplary communications network 100 in which below illustrated embodiments may be implemented. It is to be understood a communication network 100 is a geographically distributed collection of nodes interconnected by communication links and segments for transporting data between end nodes, such as personal computers, work stations, smart phone devices, tablets, televisions, sensors and or other devices such as automobiles, etc. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, or Powerline Communications (PLC), and others.

FIG. 1 is a schematic block diagram of an example communication network 100 illustratively comprising nodes/devices 101-108 (e.g., sensors 102, client computing devices 103 (e.g., network monitoring devices), smart phone devices 105, web servers 106, routers 107, switches 108, databases, and the like) interconnected by various methods of communication. For instance, the links 109 may be wired links or may comprise a wireless communication medium, where certain nodes are in communication with other nodes, e.g., based on distance, signal strength, current operational status, location, etc. Moreover, each of the devices can communicate data packets (or frames) 142 with other devices using predefined network communication protocols as will be appreciated by those skilled in the art, such as various wired protocols and wireless protocols etc., where appropriate. In this context, a protocol consists of a set of rules defining how the nodes interact with each other. Those skilled in the art will understand that any number of nodes, devices, links, etc. may be used in the computer network, and that the view shown herein is for simplicity. Also, while the embodiments are shown herein with reference to a general network cloud, the description herein is not so limited, and may be applied to networks that are hardwired.

As will be appreciated by one skilled in the art, aspects of the illustrated embodiments may be embodied as a system, method or computer program product. Accordingly, aspects of the illustrated embodiments may take the form of an entirely hardware embodiment, an entirely software embodiment (including firmware, resident software, micro-code, etc.) or an embodiment combining software and hardware aspects that may all generally be referred to herein as a “device”, “apparatus”, “module” or “system.” Furthermore, aspects of the illustrated embodiments may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device. A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++, Python, or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the illustrated embodiments are described below with reference to flowchart illustrations and/or block diagrams of methods, apparatus (systems) and computer program products according to the illustrated embodiments. It will be understood that each block of the flowchart illustrations and/or block diagrams, and combinations of blocks in the flowchart illustrations and/or block diagrams, can be implemented by computer program instructions. These computer program instructions may be provided to a processor of a computer device, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

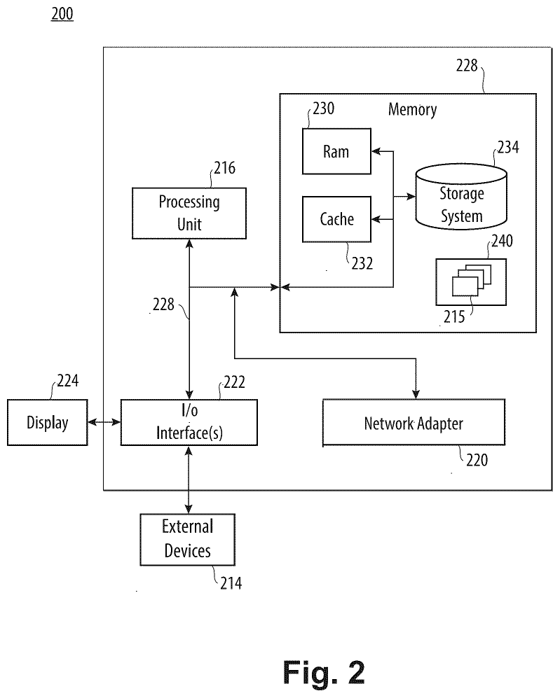

FIG. 2 is a schematic block diagram of an example network computing device 200 (e.g., client computing device 103, server 106, etc.) that may be used (or components thereof) with one or more embodiments described herein (e.g., as one of the nodes shown in the network 100) for determining the probability of an incident occurring to one or more computer applications resulting from one or more application change attributes through implementation of machine learning (ML) techniques. As explained above, in different embodiments these various devices are configured to communicate with each other in any suitable way, such as, for example, via communication network 100.

Device 200 is intended to represent any type of computer system capable of carrying out the teachings of various illustrated embodiments. Device 200 is only one example of a suitable system and is not intended to suggest any limitation as to the scope of use or functionality of the illustrated embodiments described herein. Regardless, computing device 200 is capable of being implemented and/or performing any of the functionality set forth herein, particularly for determining the probability of an incident occurring to one or more computer applications resulting from one or more application change attributes through implementation of machine learning (ML) techniques. These determined probabilities of incident occurrences advantageously provide early indication of the likelihood of an incident occurring via probabilistic machine learning modeling.

It is to be understood and appreciated that computing device 200 is operational with numerous other general purpose or special purpose computing system environments or configurations. Examples of well-known computing systems, environments, and/or configurations that may be suitable for use with computing device 200 include, but are not limited to, personal computer systems, server computer systems, thin clients, thick clients, hand-held or laptop devices, multiprocessor systems, microprocessor-based systems, network PCs, minicomputer systems, and distributed data processing environments that include any of the above systems or devices, and the like. Computing device 200 may be described in the general context of computer system-executable instructions, such as program modules, being executed by a computer system. Generally, program modules may include routines, programs, objects, components, logic, data structures, and so on that perform particular tasks or implement particular abstract data types. Computing device 200 may be practiced in distributed data processing environments where tasks are performed by remote processing devices that are linked through a communications network 100. In a distributed data processing environment, program modules may be located in both local and remote computer system storage media including memory storage devices.

The components of device 200 may include, but are not limited to, one or more processors or processing units 216, a system memory 228, and a bus 218 that couples various system components including system memory 228 to processor 216. Bus 218 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus. Computing device 200 typically includes a variety of computer system readable media. Such media may be any available media that is accessible by device 200, and it includes both volatile and non-volatile media, removable and non-removable media.

System memory 228 can include computer system readable media in the form of volatile memory, such as random-access memory (RAM) 230 and/or cache memory 232. Computing device 200 may further include other removable/non-removable, volatile/non-volatile computer system storage media. By way of example only, storage system 234 can be provided for reading from and writing to a non-removable, non-volatile magnetic media (not shown and typically called a “hard drive”). Although not shown, a magnetic disk drive for reading from and writing to a removable, non-volatile magnetic disk, and an optical disk drive for reading from or writing to a removable, non-volatile optical disk such as a CD-ROM, DVD-ROM or other optical media can be provided. In such instances, each can be connected to bus 218 by one or more data media interfaces. As will be further depicted and described below, memory 228 may include at least one program product having a set (e.g., at least one) of program modules that are configured to carry out the functions of embodiments of illustrated embodiments such as determining the probability of an incident occurring to one or more computer applications resulting from one or more application change attributes through implementation of machine learning (ML) techniques.

Program/utility 240, having a set (at least one) of program modules 215, such as underwriting module, may be stored in memory 228 by way of example, and not limitation, as well as an operating system, one or more application programs, other program modules, and program data. Each of the operating system, one or more application programs, other program modules, and program data or some combination thereof, may include an implementation of a networking environment. Program modules 215 generally carry out the functions and/or methodologies of the illustrated embodiments as described herein for detecting one or more anomalies in one or more networked computer devices (e.g., 103, 106).

Device 200 may also communicate with one or more external devices 214 such as a keyboard, a pointing device, a display 224, etc.; one or more devices that enable a user to interact with computing device 200; and/or any devices (e.g., network card, modem, etc.) that enable computing device 200 to communicate with one or more other computing devices. Such communication can occur via Input/Output (I/O) interfaces 222. Still yet, device 200 can communicate with one or more networks such as a local area network (LAN), a general wide area network (WAN), and/or a public network (e.g., the Internet) via network adapter 220. As depicted, network adapter 220 communicates with the other components of computing device 200 via bus 218. It should be understood that although not shown, other hardware and/or software components could be used in conjunction with device 200. Examples, include, but are not limited to: microcode, device drivers, redundant processing units, external disk drive arrays, RAID systems, tape drives, and data archival storage systems, etc.

FIGS. 1 and 2 are intended to provide a brief, general description of an illustrative and/or suitable exemplary environment in which the below described illustrated embodiments may be implemented. FIGS. 1 and 2 are exemplary of a suitable environment and are not intended to suggest any limitation as to the structure, scope of use, or functionality of an illustrated embodiment. A particular environment should not be interpreted as having any dependency or requirement relating to any one or combination of components illustrated in an exemplary operating environment. For example, in certain instances, one or more elements of an environment may be deemed not necessary and omitted. In other instances, one or more other elements may be deemed necessary and added.

It is to be understood the embodiments described herein are preferably provided with Machine Learning (ML)/Artificial Intelligence (AI) techniques for determining the probability of an incident occurring to one or more computer applications in one or more networked computer devices (e.g., computer server device 106) resulting from one or more application change attributes through implementation of machine learning (ML) techniques. The computer system 200 is preferably integrated with an AI system (as also described below) that is preferably coupled to a plurality of external databases/data sources that implements machine learning and artificial intelligence algorithms in accordance with the illustrated embodiments. For instance, the AI system may include two subsystems: a first sub-system that learns from historical data; and a second subsystem to identify and recommend one or more parameters or approaches based on the learning for detecting anomaly events in computer devices. It should be appreciated that although the AI system may be described as two distinct subsystems, the AI system can also be implemented as a single system incorporating the functions and features described with respect to both subsystems.

In accordance with the illustrated embodiments described herein, artificial intelligence refers to the field of studying artificial intelligence or methodology for making artificial intelligence, and machine learning refers to the field of defining various issues dealt with in the field of artificial intelligence and studying methodology for solving the various issues. Machine learning is defined as an algorithm that enhances the performance of a certain task (e.g., detecting data anomalies) through a steady experience with the certain task.

Also in accordance with certain illustrated embodiments, a neural network (NN) may be used as the trained ML model for determining the probability of an incident occurring to one or more computer applications in one or more computer devices (e.g., computer server device 106) resulting from one or more application change attributes through implementation of machine learning (ML) techniques. It is to be apricated that a neural network is a model used in machine learning and may mean a whole model of problem-solving ability which is composed of artificial neurons (nodes) that form a network by synaptic connections. The artificial neural network can be defined by a connection pattern between neurons in different layers, a learning process for updating model parameters, and an activation function for generating an output value. The artificial neural network preferably includes an input layer, an output layer, and one or more hidden layers. Each layer includes one or more neurons, and the artificial neural network may include a synapse that links neurons to neurons. In the artificial neural network, each neuron may output the function value of the activation function for input signals, weights, and deflections input through the synapse.

It is to be understood and appreciated that model parameters refer to parameters determined through learning and include a weight value of synaptic connection and deflection of neurons. A hyperparameter means a parameter to be set in the machine learning algorithm before learning, and typically includes a learning rate, a repetition number, a mini batch size, and an initialization function. The purpose of the learning of the neural network may be to determine the model parameters that minimize a loss function. The loss function may be used as an index to determine optimal model parameters in the learning process of the neural network. Machine learning may be classified into supervised learning, unsupervised learning, and reinforcement learning according to a learning method. The supervised learning may refer to a method of learning a neural network in a state in which a label for learning data is given, and the label may mean the correct answer (or result value) that the neural network must infer when the learning data is input to the artificial neural network. The unsupervised learning may refer to a method of learning a neural network in a state in which a label for learning data is not given. The reinforcement learning may refer to a learning method in which an agent defined in a certain environment learns to select a behavior or a behavior sequence that maximizes cumulative compensation in each state.

Is it to also be appreciated that machine learning, which is implemented as a deep neural network (DNN) including a plurality of hidden layers among neural networks, is also referred to as deep learning, and the deep learning is part of machine learning.

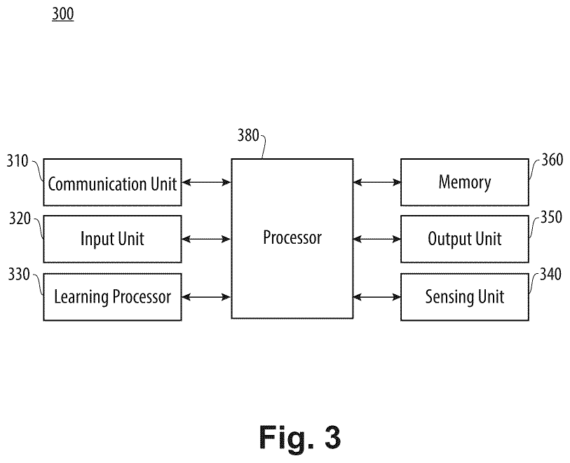

Referring now to FIG. 3, it illustrates an Artificial Intelligence (AI) monitoring device 300 according to an embodiment of the illustrated embodiments. The AI monitoring device 300 may be implemented by a stationary device or a mobile device, such as a web server, a desktop computer, a notebook, a desktop computer, and the like.

In conjunction with FIGS. 1 and 2, FIG. 3 illustrates the AI monitoring device 300 operatively coupled to, or integrated with computing device 200, in accordance with the illustrated embodiments described herein. AI monitoring device 300 preferably includes a communication unit 310, an input unit 320, a learning processor 330, a sensing unit 340, an output unit 350, a memory 360, and a processor 380. The communication unit 310 may transmit and receive data to and from external devices, such as other AI devices, by using wire/wireless communication technology. For example, the communication unit 310 may transmit and receive historical and contemplated application change attributes, a user input, a learning model, and a control signal to and from external devices, such as AI server 400.

The communication technology used by the communication unit 310 preferably includes GSM (Global System for Mobile communication), CDMA (Code Division Multi Access), LTE (Long Term Evolution), 5G, WLAN (Wireless LAN), Wi-Fi (Wireless-Fidelity), Bluetooth™ RFID (Radio Frequency Identification), Infrared Data Association (IrDA), ZigBee, NFC (Near Field Communication), and the like.

In accordance with the illustrated embodiments, the input unit 320 may acquire various kinds of data, including, but not limited to application change attributes. The input unit 320 may acquire a learning data for model learning (e.g., historical data related to certain application change attributes) and input data (e.g., contemplated application change attributes) to be used when an output is acquired by using a learning model. The input unit 320 may acquire raw input data. In this case, the processor 380 or the learning processor 330 may extract an input feature by preprocessing the input data. The aforesaid input data provided to the input unit 320 may further consist of Configuration Items (CI). For instance, a CI may be a group of software that is treated as a single entity by a configuration management (CM) system. CIs can be of varying complexity, size, and type, and can include: a single software package, a single module, a minor hardware component, an entire networked system (including software, hardware, and documentation). A CI encompasses software configured items (e.g., what is the change “on” and what are affected by the change, such as (but not limited to): user changes; database changes; server changes and application changes).

Additionally, the aforesaid data provided to the input unit 320 may consist of a “success score” determined for the group the person who is submitting the data to the input unit 320 is associated with, or the group that is impacted by the change. The “success score” is to be understood to consist of a numerical value indicative of how successful the aforesaid group, or impacted group, was with submitting prior application change requests. For instance, the success score is algorithmically determined based on weighted sums of closure codes (e.g., indicates the reason for closing requests (service and incident requests) as request completion successful, failed, canceled, postponed, etc.), major incidents caused (e.g., major incidents are negative sums). Additionally, in certain embodiments, such a success score may be used for training the ML model (as described below with reference to step 530 of process 500).

In certain embodiments, the learning processor 330 learns (trains) a ML model by using learning data for determining the probability of incident occurrence to one or more applications resulting from one or more application change attributes. The ML model in certain embodiments infers a result value for new input data rather than learning data, and the inferred value may be used as a basis for determination to perform a certain operation.

In certain illustrated embodiments, the learning processor 330 performs AI processing together with the learning processor 440 of the AI server 400, and the learning processor 330 may include a memory integrated or implemented in the AI monitoring device 300. Alternatively, in other illustrated embodiments, the learning processor 330 is implemented by using the memory 360, an external memory directly connected to the AI monitoring device 300, or a memory held in an external device.

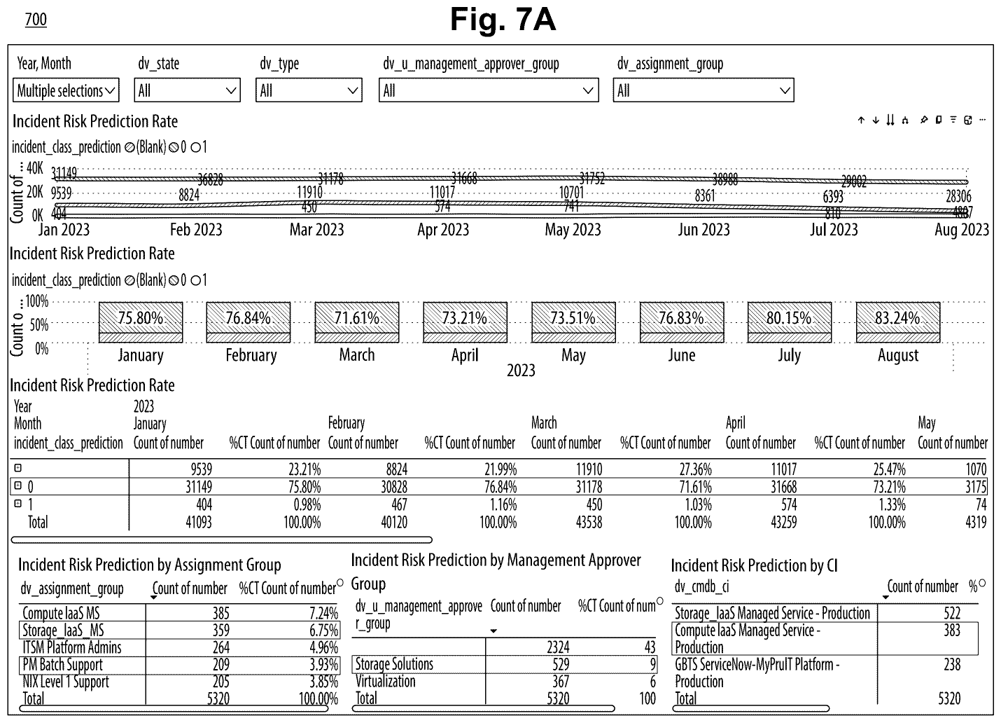

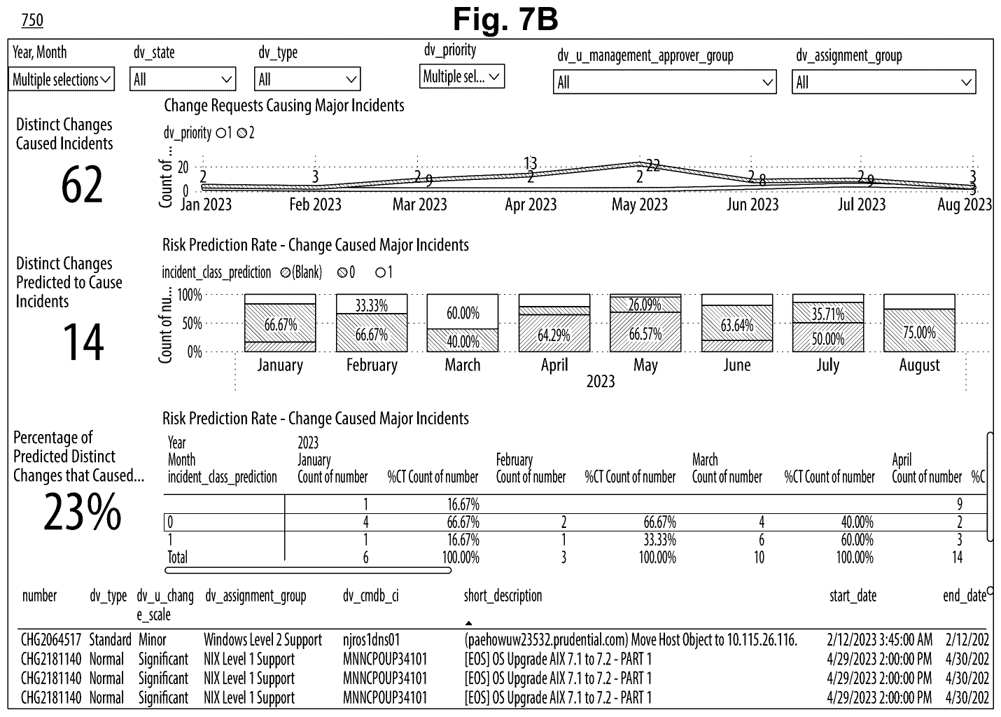

The output unit 350 preferably includes a display unit for outputting/displaying relevant information to a user in accordance with the illustrated embodiments described herein (e.g., the exemplary dashboard displays 700 and 750 of FIGS. 7A and 7B). The memory 360 preferably stores data that supports various functions of the AI monitoring device 300. For example, the memory 360 may store input data acquired by the input unit 320, learning data, a learning model, a learning history, and the like.

The processor 380 preferably determines at least one executable operation of the AI monitoring device 300 based on information determined or generated by using a data analysis algorithm or a machine learning algorithm. The processor 380 may control the components of the AI monitoring device 300 to execute the determined operation. To this end, the processor 380 may request, search, receive, or utilize time-based metric data of the learning processor 330 or the memory 360. The processor 380 may control the components of the AI monitoring device 300 to execute the predicted operation or the operation determined to be desirable among the at least one executable operation. When the connection of an external device is required to perform a determined operation, the processor 380 may generate a control signal for controlling the external device and may transmit the generated control signal to the external device. The processor 380 may acquire intention information for the user input and may determine the user's requirements based on the acquired intention information. In some embodiments, the processor 380 may acquire the intention information corresponding to the user input by using at least one of a speech to text (STT) engine for converting speech input into a text string or a natural language processing (NLP) engine for acquiring intention information of a natural language.

In certain illustrated embodiments, at least one of the STT engine or the NLP engine may be configured as an artificial neural network, at least part of which is learned according to the machine learning algorithm. Thus, in certain illustrated embodiments, at least one of the STT engine or the NLP engine may be learned by the learning processor 330, or may be learned by the learning processor 340 of the AI server 400, or may be learned by their distributed processing. The processor 380 may collect history information including the operation contents of the AI monitoring device 300 or the user's feedback on the operation and may store the collected history information in the memory 360 or the learning processor 330 or transmit the collected history information to the external device such as the AI server 400. The collected history information may be used to update the learning model.

The processor 380 may control at least part of the components of AI monitoring device 300 so as to drive an application program stored in memory 360. Furthermore, the processor 380 may operate two or more of the components included in the AI monitoring device 300 in combination so as to drive the application program.

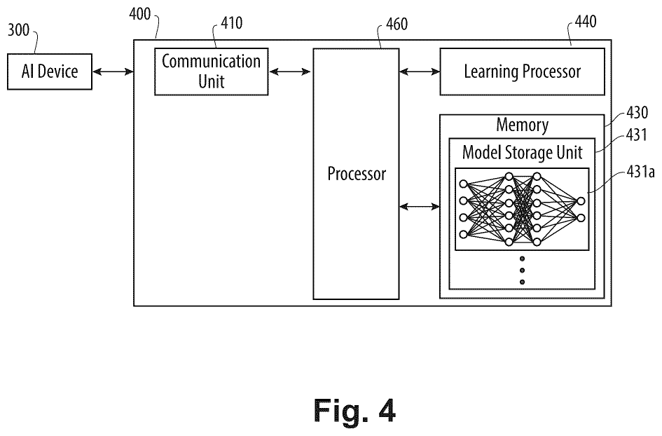

FIG. 4 illustrates an AI server 400 according to the certain illustrated embodiments that may utilize a neural network for ML. It is to be appreciated that the AI server 400 may refer to a device that learns an artificial neural network by using a machine learning algorithm or uses a learned artificial neural network. The AI server 400 may include a plurality of servers to perform distributed processing, or may be defined as a 5G network. Preferably, the AI server 400 is included as a partial configuration of the AI monitoring device 300, and performs at least part of the AI processing together. The AI server 400 may include a communication unit 410, a memory 430, a learning processor 440, a processor 460, and the like. The communication unit 410 can transmit and receive data to and from an external device such as the AI monitoring device 300. The memory 430 may include a model storage unit 431. The model storage unit 431 may store a learning or learned model (or a neural network 431a) through the learning processor 440.

The learning processor 440 may learn the artificial neural network 431a by using the learning data. The learning model may be used in a state of being mounted on the AI server 400 of the neural network or may be used in a state of being mounted on an external device such as the AI monitoring device 300. The learning model may be implemented in hardware, software, or a combination of hardware and software. If all or part of the learning models are implemented in software, one or more instructions that constitute the learning model may be stored in memory 430. The processor 460 may infer the result value for new input data by using the learning model and may generate a response or a control command based on the inferred result value.

With the exemplary communication network 100 (FIG. 1), computing device 200 (FIG. 2), AI monitoring device 300 (FIG. 3) and AI server 400 (FIG. 4) being generally shown and discussed above, description of certain illustrated embodiments will now be provided. It is to be understood and appreciated that exemplary embodiments implementing one or more components of FIGS. 1-4 relate to an Artificial Intelligence (AI) based computer system and method for determining a probability of incident occurrence resulting from one or more changes to one or more computer applications. It is to be understood and appreciated that FIGS. 1-4 are intended to provide a brief, general description of an illustrative and/or suitable exemplary environment in which the below described illustrated embodiments may be implemented. FIGS. 1-4 are exemplary of a suitable environment and are not intended to suggest any limitation as to the structure, scope of use, or functionality of an illustrated embodiment. A particular environment should not be interpreted as having any dependency or requirement relating to any one or combination of components illustrated in an exemplary operating environment. For example, in certain instances, one or more elements of an environment may be deemed not necessary and omitted. In other instances, one or more other elements may be deemed necessary and added.

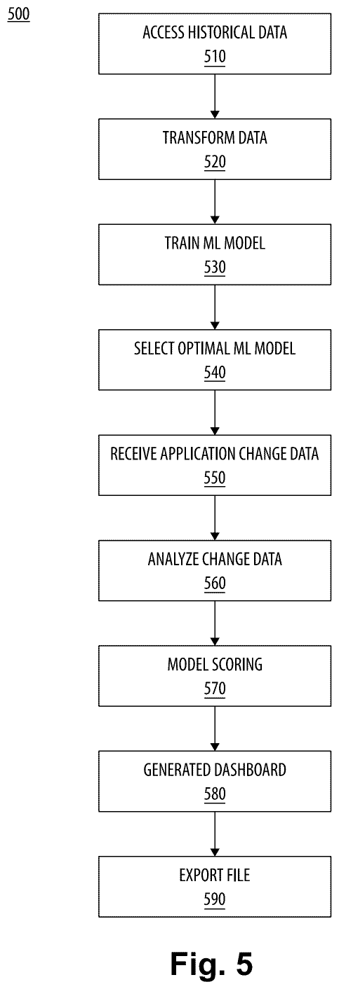

With reference now to the illustrated embodiment of FIG. 5, shown is an exemplary process 500 that utilizes Machine Learning (ML) techniques to determine the probability of an incident occurrence, via AI monitoring device 300, resulting from one or more application change attributes to one or more applications executing on one or more networked devices (e.g., 101-108). It is noted that this is particularly advantageous in that it enables application administrators implementing the one or more application change attributes to understand the potential impact to one or more applications resulting from one or more application change attributes so as to prepare proactively for any potential impacting incidents.

Starting at step 510, AI monitoring device 300 preferably accesses historical change and incident data from a prescribed time period (e.g., multi-year) consisting of application changes and resulting incident occurrences caused by the application changes to one or more networked devices (e.g., 101-108), which is to be utilized for training a ML model as described in conjunction with step 530. Preferably, the aforesaid accessed historical change and incident data includes cleansing the historical data, including imputing any missing values. Next at step 520 the historical change and incident data is preferably transformed using one or more data transformation techniques, including (but not limited to): pandas, numpy, datetime, sklearn, itertools, sqlalchemy, redshift_connector, collections, pytz, pickle, collections, nltk, ssl, re, contractions, unidecode, wordnet, spacy, stop_words, create_engine, types. Additionally, the AI monitoring device 300 in certain embodiments creates groupings from the historical data, extracts optimal timeframe data from the historical data, and encodes application change attributes.

Next, at step 530, the AI monitoring device 300 trains Machine Learning (ML) models to identify probability of likelihood of one or more incidents occurring to one or more computer applications attributable to one or more changes to one or more computer applications. In accordance with the illustrated embodiments, and as described herein, a ML model preferably includes a plurality of input parameters each corresponding to a different application change attribute, and an output having output labels and weights. The training of a ML model may include (and is not to be understood to be limited to) one or more the following exemplary ML training techniques: LabelEncoder, XGboost, ExtraTreesClassifier, LinearSVC, DecisionTreeClassifier, RandomForestClassifier, GradientBoostingClassifier, classification_report, confusion_matrix, ConfusionMatrixDisplay, roc_curve, auc, AdaBoostClassifier, LinearSVC, and GridSearchCV. In certain embodiments, the one or more machine learning techniques includes utilization of five-fold cross-validation (CV) techniques. In other illustrated embodiments, training the ML model includes the use neural network processing techniques (e.g., AI server 400). In other certain embodiments, the ML model is trained using “task” data (e.g., what was the root cause, corrective and preventive action details of a prior incident). For instance, a “task” may be defined as why did a certain server crash, with the root cause being the reasoning why a sufficient amount of memory was not available to the server at the time of the incident.

In accordance with the illustrated embodiments, training ML models to determine a probability of incident occurrence resulting from one or more changes to one or more computer applications includes processing at least the accessed historical incident occurrence records that include historical changes and incident records relating to one or more applications (step 510) such that a ML model is trained using processed historical changes and incident records. Preferably, processing the historical incident changes and incident records includes converting unstructured data to structured data for processing by the ML model network, and also preferably includes performing Natural Language Processing (NLP) techniques to transform at least a portion of the historical incident changes and incident records for processing by a trained ML model. In certain embodiments, one or more of Receiver Operator Characteristic (ROC) and Area Under the Curve (AUC) calculations are utilized to visually identify optimal probability decision points for training the ML model. Additionally, in certain embodiments, a confusion matrix is utilized to summarize performance of a ML model on a set of test data used for training a ML model. Preferably, the confusion matrix is computed using a confusion matrix function applied to true and predicted labels, which includes computing true positive (TP), false positive (FP), false negative (FN), and true negative (TN) values for the output layer.

Once a ML model is trained, the accuracy of a trained ML model is determined by preferably determining a probability of incident occurrence by using a F1 score for improving the performance of a binary classification model. Next at step 540, an optimized trained ML model is selected, which preferably includes determining an optimal ML model with optimized hyperparameters preferably utilizing grid search capabilities or randomized search. Preferably, the optimal hyperparameters are set using a grid search method or randomized search.

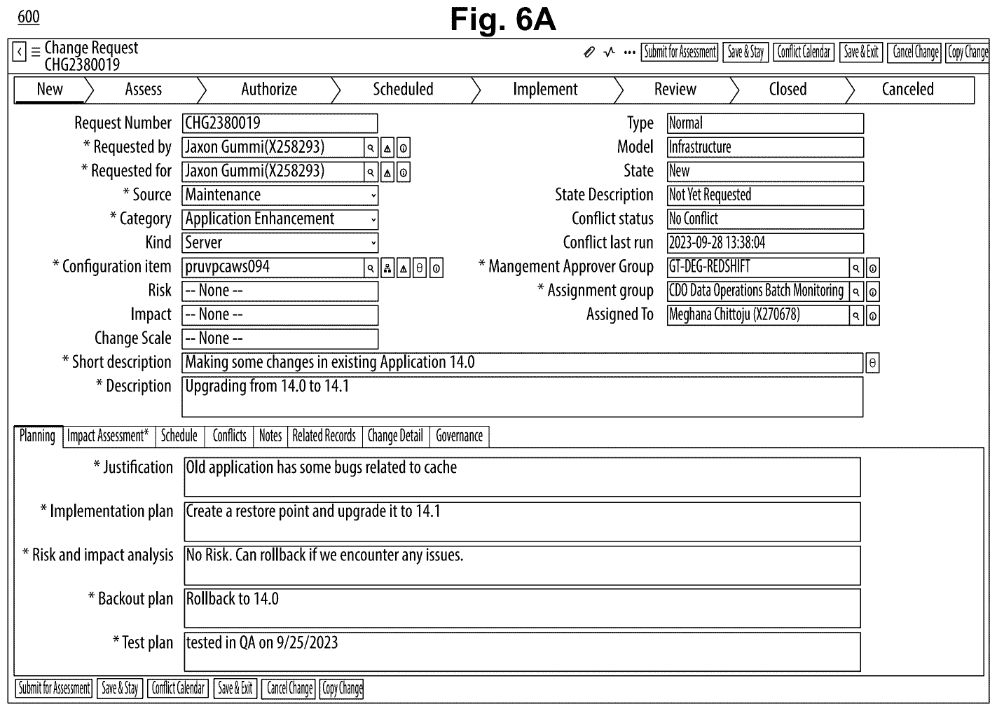

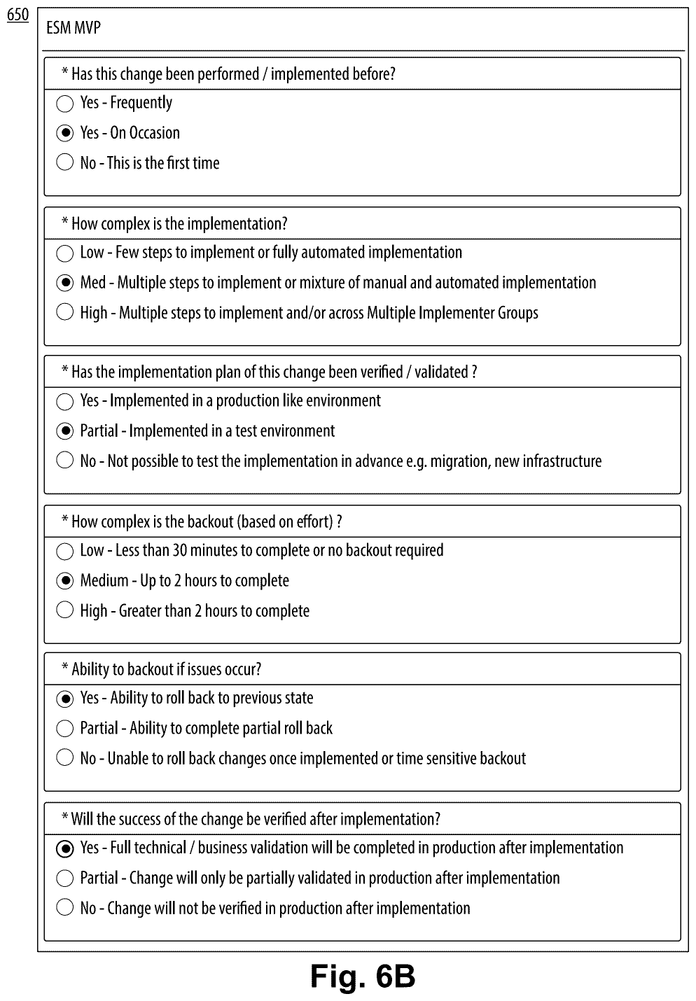

Once an optimal trained ML model has been determined (step 540), one or more application change attributes to one or one or more applications executing on one or more networked devices (e.g., 101-108) are input to the AI monitoring device 300 to determine the probability of one or more incident occurrences to the one or one or more applications resulting from the aforesaid one or more application change attributes, which change attribute may consist of contemplated changes (e.g., future, and not yet implemented) to the aforesaid one or more applications, step 550. In accordance with certain illustrated embodiments, FIGS. 6A and 6B illustrate exemplary screen shots 600 and 650, preferably generated by device 300, depicting a process for a user to input on or more scheduled change attributes. Next, at step 560, the one or more application change attributes of step 550 are analyzed by the AI monitoring device 300 using the optimal selected trained ML model (step 540). Next, at step 570, identified by the AI monitoring device 300 are one or more incident occurrence indicators applicable to at least one application change attribute (step 550) using the optimal selected trained ML model, which preferably determines a probability determination of one or more incidents occurring corresponding to the at least one application change attribute. Preferably, each incident occurrence indicator includes a label and a weight output from the output of the selected trained ML model. It is to be understood and appreciated that in accordance with the illustrated embodiments, the ML model is trained to provide model scoring on the at least one application change attribute (step 550) that includes providing output data indicating a probability of incident occurrence resulting from one or more changes to one or more computer applications.

Once the probability of incident occurrence resulting from one or more changes to one or more computer applications has been determined (step 570), next at step 580, the AI monitoring device 300, in certain illustrated embodiments, generates a GUI display (e.g., dashboard) on a user's computer device visual indicating performance metrics associated with the model scoring regarding the probability of incident occurrence resulting from one or more changes to one or more computer applications. For example, such an illustrative display 600 is show in FIGS. 7A and 7B.

Additionally in certain illustrated embodiments, at step 590, an incident occurrence file (e.g., pickle file) is preferably exported. For instance, in certain illustrated embodiments, generated and exported to a database (e.g., 360), are Python objects (e.g., a Pickle file) for serializing and deserializing the output layer indicative of the probability of incident occurrence resulting from one or more changes to one or more computer applications, for subsequent use by the ML model. In certain illustrated embodiments, opportunities for additional features is also investigated wherein additional raw data is ingested into the ML pipeline of AI determining device 300 for retraining the aforesaid ML model.

It is to be understood and appreciated that in accordance with certain illustrated embodiments, the above-described effective trained ML/AI model is utilized to predict a likelihood of a near real-time incident to one or more computer applications by forecasting risk for a scheduled change request. In certain embodiments, possible preventive actions may be employed for high-risk change requests as predicted by the aforesaid trained ML model to mitigate foreseeable incidents to the one or more applications. For instance, an Application Programming Interface (API) may be configured utilizing the aforesaid the effective ML/AI model parameters (which includes the required input attributes and desired outputs).

It is to be further understood and appreciated that in accordance with certain illustrated embodiments, the trained ML model is implemented periodically by the AI monitoring device to determine a probability of incident occurrence resulting from one or more scheduled changes to one or more computer applications, and wherein the ML model is integrated with an IT management workflow application (e.g., such as the ServiceNow™ application for managing incident, problem and change IT operational events). For instance, a Representational State Transfer (REST) application program interface (API) is integrated with the ML model with the IT management workflow application, wherein the output of ML model is provided via the REST API providing notice to a user of the probability of one or more incidents occurring corresponding to the at least one application change attribute.

In certain illustrated embodiments, the AI monitoring device 300 is further configured and operative to determine corrective actions to be taken to obviate/overcome a determined incident based upon a change request. And in other illustrated embodiments, the AI monitoring device 300 is further configured and operative to initiate/implement the aforesaid corrective actions in the one or more applications that are to be subject to a change request so as to obviate the occurrence of a resulting incident.

Thus, what has been described above is an advantageous network tool (e.g., AI monitoring device 300) for identifying potentially impactful changes caused by one or more contemplated application change requests, so as to provide accurate and timely incident prediction across diverse use cases, ensuring business continuity. For instance, the following illustrative use scenario exemplifies the advantages of the certain illustrated embodiments described herein. The scenario includes an enterprise network change is scheduled during a day that is considered routine and traditionally very low risk. Due to the urgency of the network change, it is scheduled to run during normal business hours. The trained ML/AI model in accordance with the illustrated embodiments utilizes historic change/incident data and the future change calendar to predict that a network change very similar to the contemplated enterprise network change caused a major outage that resulted in broad disruption in business service and carried a high financial impact and reputational damage. Thus, advantages of the illustrated embodiments include generating reports and visuals (dashboards) which detect this issue and make appropriate personal aware of a change that could represent high risk. Thus, a help/service ticket may be flagged and escalated to ensure awareness was created concerning this potential change.

With the certain illustrated embodiments described above, descriptions of the various embodiments of the illustrated embodiments have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for determining a probability of incident occurrence resulting from one or more changes to one or more computer applications executing on a computer network, comprising the steps:
training, by a processor, a Machine Learning (ML) model to identify probability of likelihood of one or more incidents occurring to one or more computer applications attributable to one or more changes to the one or more computer applications, the trained ML model including a plurality of input parameters each corresponding to a different application change attribute, and an output having output labels and weights associated with computer application changes resulting from the input parameters;
receiving, in the processor, information corresponding to at least one application change attribute applicable to the at least one application;
analyzing, by the processor, the at least one application change attribute using the trained ML model;
identifying, by the processor, by utilizing the trained ML model, one or more incident occurrence indicators applicable to the at least one application change attribute, wherein each of the one or more incident occurrence indicators includes a label and a weight output from the output of the trained ML model; and
determining, by the processor, a probability of one or more incidents occurring to the at least one application corresponding to the at least one application change attribute contingent upon a label and weight output from the trained ML model attributable to at least one application change variable.

2. The computer-implemented method as recited in claim 1, wherein training a ML model to determine a probability of incident occurrence resulting from one or more changes to one or more computer applications further includes:
processing, by the processor, at least a historical incident occurrence record that includes historical changes and incident records relating to one or more applications; and
training the ML model using the processed historical changes and incident records.

3. The computer-implemented method as recited in claim 2, wherein processing the historical incident changes and incident records includes converting unstructured data to structured data suitable for training the ML model.

4. The computer-implemented method as recited in either claim 3, wherein processing the historical incident changes and incident records further includes performing Natural Language Processing (NLP) techniques to transform at least a portion of the historical incident changes and incident records to a data format compatible for further training the trained ML model.

5. The computer-implemented method as recited in claim 4, wherein training the ML model further includes utilization of hyperparameter optimization having grid search capabilities or randomized search capabilities.

6. The computer-implemented method as recited in claim 5, wherein training the ML model further includes utilization of five-fold cross-validation (CV) techniques.

7. The computer-implemented method as recited in claim 1, further including the step measuring, by the processor, the accuracy of the trained ML model for determining a probability of incident occurrence by using a F1 score for improving the performance of a binary classification model.

8. The computer-implemented method as recited in claim 1, further including the step generating, by the processor, a Graphical User Interface (GUI) visually identifying optimal probability decision points for training the ML model by utilizing one or more of Receiver Operator Characteristic (ROC) and Area Under the Curve (AUC) calculations.

9. The computer-implemented method as recited in claim 1, wherein a confusion matrix is utilized to summarize performance of the ML model applied on a set of test data used for training the ML model.

10. The computer-implemented method as recited in claim 9, wherein the confusion matrix is computed using a confusion matrix function applied to true and predicted labels, which includes computing true positive (TP), false positive (FP), false negative (FN), and true negative (TN) values for the output of the trained ML model.

11. The computer-implemented method as recited in claim 1, wherein the trained ML model is implemented periodically to determine a probability of incident occurrence resulting from one or more scheduled changes to one or more computer applications.

12. The computer-implemented method as recited in claim 8, wherein the trained ML model is integrated with an IT management workflow application utilizing a Representational State Transfer (REST) application program interface (API) for integrating the ML model with the IT management workflow application.

13. The computer-implemented method as recited in claim 12, wherein the output of the trained ML model is provided via the REST API providing notification on the GUI indicating probability of one or more incidents occurring corresponding to the at least one application change attribute.

14. The computer-implemented method as recited in claim 13, further including the step generating, by the processor, on the GUI, indication of performance metrics associated with model scoring regarding the probability of incident occurrence resulting from one or more changes to one or more computer applications.

15. The computer-implemented method as recited in claim 1, further including the step generating, and exporting to a database, by the processor, a Pickle file for serializing and deserializing the output layer indicative of the probability of incident occurrence resulting from one or more changes to one or more computer applications, for further training the ML model.

16. The computer-implemented method as recited in claim 1, wherein training the ML model further includes utilization of historical data from a prescribed time period consisting of application changes and resulting incident occurrences caused by the application changes.

17. The computer-implemented method as recited in claim 16, wherein processing the historical data further includes creating groupings from the historical data, extracting optimal timeframe data from the historical data, and encoding application change attributes.

18. The computer-implemented method as recited in claim 1, wherein the trained ML model is configured to provide real-time indication of a probability of incident occurrence resulting from one or more changes to one or more computer applications.

19. A computer-implemented method for training a machine learning (ML) model to determine a probability of incident occurrence resulting from one or more changes to one or more computer applications executing on a computer network, comprising the step:
generating, by a processor, a Machine Learning (ML) model trained to identify probability of likelihood of one or more incidents occurring to one or more computer applications attributable to one or more changes to the one or more computer applications, the trained ML model consisting of:
(i) a plurality of input parameters each corresponding to a different application change attribute; and
(ii) an output having output labels and weights associated with computer application changes resulting from the input parameters.

20. The computer-implemented method as recited in claim 19, wherein training a ML model to determine a probability of incident occurrence resulting from one or more changes to one or more computer applications further includes the steps:
processing, by the processor, at least a historical incident occurrence record that includes historical changes and incident records relating to one or more applications; and
training the ML model using the processed historical changes and incident records.

21. The computer-implemented method as recited in claim 20, wherein processing the historical incident changes and incident records includes converting unstructured data to structured data suitable for processing by the ML model network.

22. The computer-implemented method as recited in either claim 21, wherein processing the historical incident changes and incident records further includes performing Natural Language Processing (NLP) techniques to transform at least a portion of the historical incident changes and incident records to a data format compatible for further training the trained ML model.

23. The computer-implemented method as recited in claim 22, wherein training the ML model further includes utilization of hyperparameter optimization having grid search capabilities or randomized search capabilities.

24. The computer-implemented method as recited in claim 23, wherein training the ML model further includes utilization of five-fold cross-validation (CV) techniques.

25. The computer-implemented method as recited in claim 19, further including the step generating, and exporting to a database, by the processor, a Pickle file for serializing and deserializing the output layer indicative of the probability of incident occurrence resulting from one or more changes to one or more computer applications, for further training the trained ML model.

26. The computer-implemented method as recited in claim 19, wherein training the ML model further includes utilization of historical data from a prescribed time period consisting of application changes and resulting incident occurrences caused by the application changes.

27. The computer-implemented method as recited in claim 26, wherein processing the historical data further includes creating groupings from the historical data, extracting optimal timeframe data from the historical data, and encoding application change attributes.

28. The computer-implemented method as recited in claim 19, wherein the trained ML model is configured to provide real-time indication of a probability of incident occurrence resulting from one or more changes to one or more computer applications.

29. A computer-implemented system for determining a probability of incident occurrence resulting from one or more changes to one or more computer applications, comprising:
a memory configured to store instructions;
a processor disposed in communication with said memory, wherein said processor upon execution of the instructions is configured to:
train a Machine Learning (ML) model to identify probability of likelihood of one or more incidents from occurring to one or more computer applications attributable to one or more changes to the one or more computer applications, the trained ML model including a plurality of input parameters each corresponding to a different application change attribute, and an output having output labels and weights;
receive information corresponding to at least one application change attribute;
analyze the at least one application change attribute using the trained ML model;
identify one or more incident occurrence indicators applicable to the at least one application change attribute using the trained ML model, wherein each incident occurrence indicator includes a label and a weight output from the output of the trained ML model; and
determine a probability of one or more incidents occurring corresponding to the at least one application change attribute contingent upon a label and weight output from the trained ML model attributable to at least one application change variable.
